(19) United States
(12) Patent Application Publication
(10) Pub. No.: US 2001/0045015 A1
(43) Pub. Date: Nov. 29, 2001

(54) Assembly technique for double row ball or roller bearings

(76) Inventor: Daniel R. McLarty, Burlington, CT (US)

Correspondence Address: MICHAEL BEST & FRIEDRICH LLP, 3773 CORPORATE PARKWAY, SUITE 360, CENTER VALLEY, PA, 18034-8217, US

(21) Appl. No.: 09/792,125

(22) Filed: Feb. 23, 2001

Related U.S. Application Data
(60) Provisional application No. 60/185,951, filed on Feb. 29, 2000.

(51) Int. Cl. B21K 1/76; B23P 17/00; B21D 53/10

(52) U.S. Cl. 29/898; 29/898.061

(57) ABSTRACT

A crush sleeve has a plurality of protrusions distributed about its inner or outer circumference, usually along its axial midpoint. A two-piece bearing ring is positioned over the crush sleeve with the protrusions between the two portions of the two-piece bearing ring. The two portions of the two-piece bearing ring are forced against the protrusions in opposite axial directions, thereby deforming the protrusions, until a desired clearance results within the bearing. The two-piece bearing ring may be either an inner or outer bearing ring.

### BACKGROUND OF THE INVENTION

This invention relates generally to double row ball or roller bearings and, more particularly, to techniques to achieve desired relative positions of the assembled elements of the roller bearings.

Typically, double row ball bearings are made by machining or grinding raceways on a single (one-piece) inner ring and single (one-piece) outer ring. For cost or assembly reasons, two inner rings (one for each row of balls) and/or two outer rings (one for each row of balls) may be provided separately and assembled, along with balls and cages, into a finished bearing. One such assembly technique utilizes an axial fit-up ring (squash ring), as disclosed in U.S. Pat. No. 3,986,754.

FIGS. 1 and 2, herein, illustrate the assembly technique of U.S. Pat. No. 3,986,754. Although effective, some difficulties may remain when using that squash ring assembly technique. Specifically, the squash ring may require too much force before it plasticly deforms, the squash ring adds cost and makes processing more difficult, and the precise locating of the squash ring in the axial direction, along the retaining sleeve, may be difficult.

The foregoing illustrates limitations known to exist in present devices and methods. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

In one aspect of the invention, this is accomplished by providing an assembly technique for a double row roller bearing comprising the steps of providing a crush sleeve having a plurality of protrusions distributed about an inner or outer circumference thereof, and forcing bearing rings against the protrusions from opposite axial directions, thereby deforming the protrusions, until a desired clearance results within the bearing.

The foregoing and other aspects will become apparent from the following detailed description of the invention when considered in conjunction with the accompanying drawing figures.

### BRIEF DESCRIPTION OF THE DRAWING FIGURES

FIG. 1 is a sectional view of a partially assembled double row ball bearing illustrating an assembling technique using a plasticly deformable squash ring according to the prior art;

FIG. 2 is a sectional view of the double row ball bearing of FIG. 1 after an axial force has been applied to deform the squash ring and complete assembly;

FIG. 3 is a pictorial view of an embodiment of a crush sleeve for use with the present invention:

FIG. 4 is an axial view of the crush sleeve of FIG. 3;

FIG. 5 is a lateral (radial) view of the crush sleeve of FIG. 3;

FIG. 6 is a sectional view of a portion of the crush sleeve of FIG. 3, as indicated by line 6-6 in FIG. 5;

FIGS. 7 through 14 are cross sectional views of tooling and progressive steps in assembling a double row ball bearing illustrating an embodiment of the present invention; and

FIGS. 15 and 16 are sectional views illustrating alternative embodiments of a crush sleeve for use with the present invention.

### DETAILED DESCRIPTION

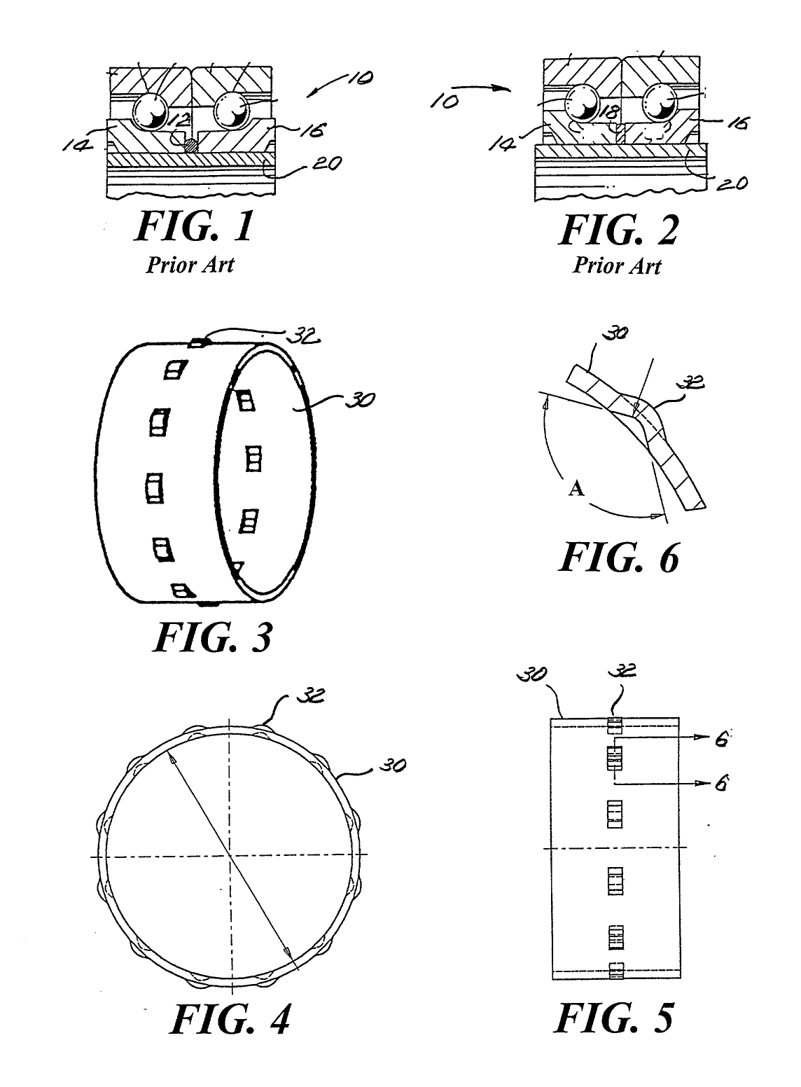

As illustrated in FIG. 1, a double row ball bearing 10 may be assembled with a plasticly deformable squash ring 12 between two portions 14 and 16 of a two-piece inner ring. When the two portions 14 and 16 are pressed together during assembly, as illustrated in FIG. 2, to achieve a desired clearance or preload condition of the ball bearing, the squash ring 12 becomes a flattened ring 18. There is no convenient means of controlling the axial location of the squash ring 12 along retaining sleeve 20, making the assembly of ball bearing 10 difficult and costly.

Unlike the prior art of FIGS. 1 and 2, the assembly technique of the present invention utilizes a crush sleeve 30, illustrated in FIGS. 3 through 6. The crush sleeve 30 may be made from tube or wrapped from strip stock and either welded or left with an open seam. The material of the crush sleeve 30 may be steel, aluminum, brass or other ductile material. As shown in the figures, discrete protrusions 32 are provided on the outside diameter of the crush sleeve 30.

The protrusions 32 locate the inner rings of the ball bearing centrally (axially) on the crush sleeve 30 and are crushable to allow internal clearance to be set during the assembly of the bearing, while compensating for axial dimensional variations. The protrusions 32 are distributed along a circumference of the crush sleeve 30 and are intermittent, e.g., periodic, to reduce the amount of material to be deformed during clearance setting, limiting the force required to do so, and to provide a space into which the deformed material may be moved.

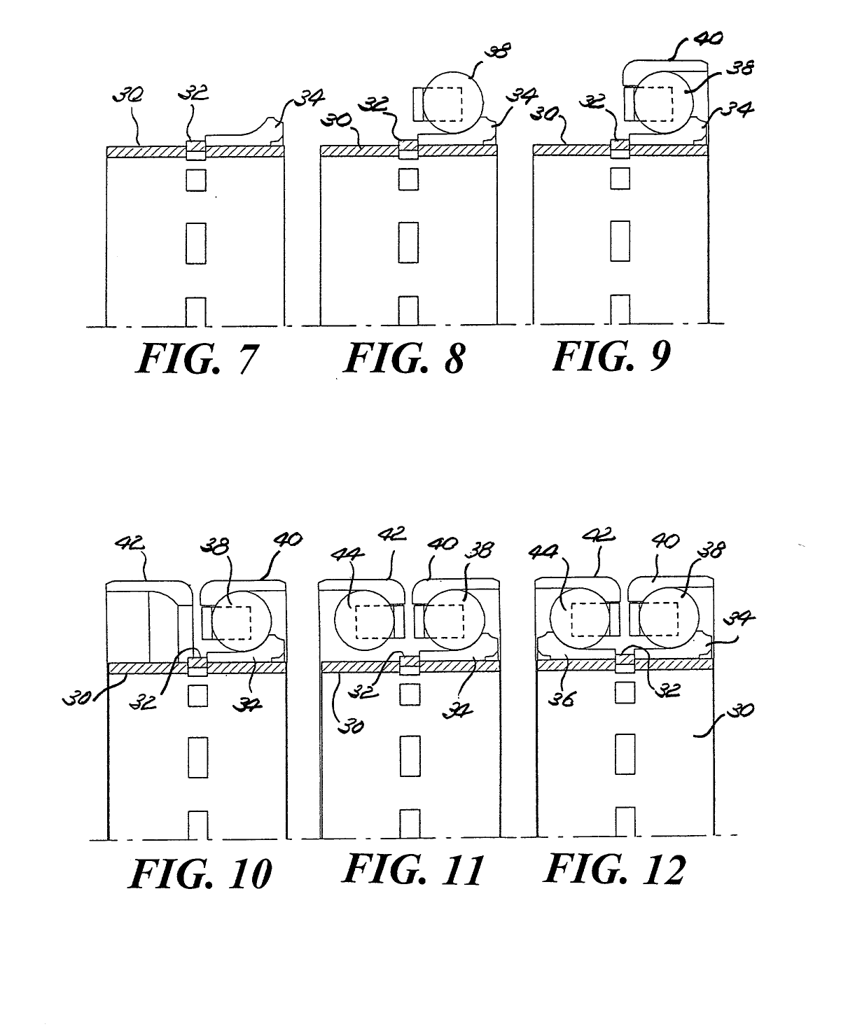

The crush sleeve 30 contains the separating force between the inner rings 34 and 36 resulting from application loads. The protrusions 32 also prevent the inner rings 34 and 36 from approaching each other due to axial loads applied during bearing installation, thereby maintaining the desired bearing clearance. When the crush sleeve 30 is designed such that the ends of the sleeve project beyond the faces of the inner rings 34 and 36, as shown in FIGS. 7 through 14, the sleeve axial length determines a consistent overall inner ring assembly axial length, as opposed to the highly variable distance between inner ring faces.

To assemble the ball or roller bearing according to an embodiment of the present invention, the first inner ring 34 is pressed on the crush sleeve 30 and against the protrusions 32, as illustrated in FIG. 7. A first ball/cage (or roller/cage) assembly 38 is then assembled on the inner ring 34, as illustrated in FIG. 8, and an outer ring 40 is assembled over the first ball/cage assembly 38, as illustrated in FIG. 9. A second outer ring 42 is then positioned over the crush sleeve 30, as illustrated in FIG. 10, and a second ball/cage (or roller/cage) assembly 44 is positioned between the outer ring 42 and the crush sleeve 30, as illustrated in FIG. 11. The second inner ring 36 is then pressed on the crush sleeve 30, as illustrated in FIG. 12.

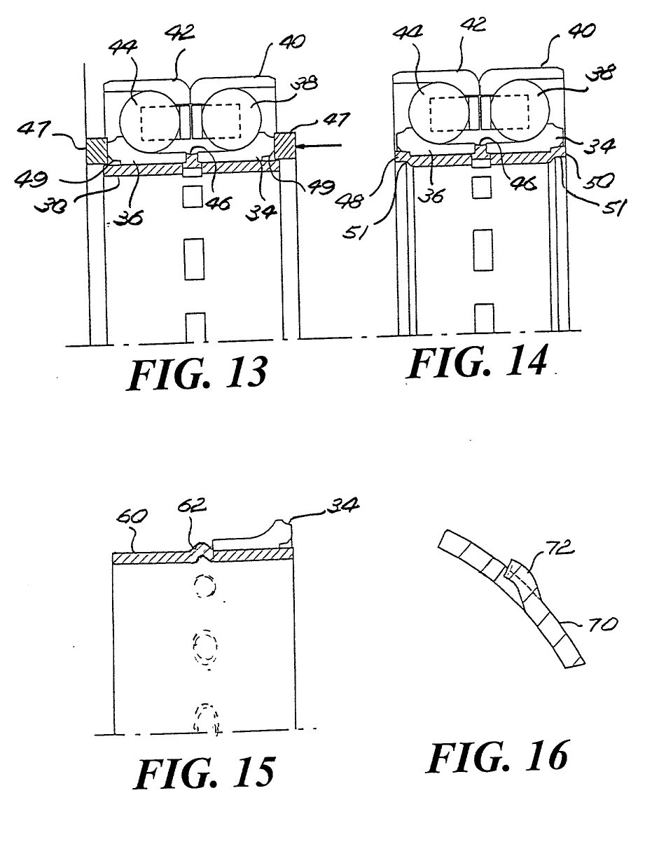

FIG. 13 illustrates crushing of the protrusions 32 into a deformed shape 46 by applying an axial force on the inner rings 34 and 36, squeezing them together with tooling members 47, to create a desired axial clearance (or preload) within the bearing. FIGS. 13 and 14 illustrate that the inner rings 34 and 36 may include a recess, for example a circumferential groove 49, such that axial ends 48 and 50 of the crush sleeve 30 may be formed over axial ends of the inner rings 34 and 36 to lock the bearing together and provide a tapered or recessed surface 51.

The protrusions may be pierced or pressed or may be formed by other means. The protrusions are not limited to the angle A illustrated in FIG. 6, e.g., 120 degrees, or the configuration shown in FIGS. 3 through 5. For example, the protrusions may be simple round or elongated bumps 62 (formed by dimples from the inside of the crush sleeve 60) as illustrated in FIG. 15, or the protrusions may be cantilevered fingers 72 extending from crush sleeve 70, as illustrated in FIG. 16. The number of protrusions may be 12, as illustrated, or any other convenient number, distributed around the circumference of the crush sleeve.

The crush sleeve assembly technique of the present invention eliminates the need for a separate component (the squash ring 12), thereby simplifying assembly and reducing cost. The deformation force can be controlled and reduced compared to that required by the squash ring 12. Significantly, the protrusions of the crush sleeve avoid the problem of axially locating the crush ring 20 and maintain the inner rings in precise location, axially. In addition to use with inner rings, the crush sleeve concept of the present invention is applicable to an inverted configuration, where the protrusions separate outer rings instead of inner rings during the assembly of the bearing.

Having described the invention, what is claimed is:

1. An assembly technique for a double row roller bearing comprising:
providing a crush sleeve having a plurality of protrusions distributed about an inner or outer circumference thereof; and
forcing portions of a two-piece bearing ring against the protrusions from opposite axial directions, thereby deforming the protrusions, until a desired clearance results within the bearing.

2. The assembly technique according to claim 1, wherein the crush sleeve is made from strip stock wrapped to form a tube.

3. The assembly technique according to claim 1, wherein the protrusions are located centrally, with respect to axial ends of the crush sleeve.

4. The assembly technique according to claim 1, wherein the protrusions are distributed at regular intervals along the circumference of the crush sleeve.

5. The assembly technique according to claim 1, wherein the crush sleeve has an axial length greater than the axial length of bearing ring, after assembly, such that the crush sleeve determines an inner ring assembly axial length.

6. The assembly technique according to claim 1, wherein the rollers are balls.

7. The assembly technique according to claim 1, wherein the two-piece bearing ring includes a recess, and wherein the crush sleeve is deformed into the recess to lock the bearing assembly together.

8. The assembly technique according to claim 7, wherein the recess is a circumferential groove along an axial end of the two-piece bearing ring such that the deformed crush sleeve provides a recessed surface of the assembled roller bearing.

9. The assembly technique according to claim 1, wherein the protrusions of the crush sleeve are made by piercing.

10. The assembly technique according to claim 9, wherein the protrusions of the crush sleeve are configured as cantilevered fingers.

11. The assembly technique according to claim 1, wherein the protrusions of the crush sleeve are made by pressing.

12. The assembly technique according to claim 1, wherein the protrusions of the crush ring are made by forming dimples from side the crush sleeve.
